(19) United States
(12) Patent Application Publication
(10) Pub. No.: US 2021/0156450 A1
(43) Pub. Date: May 27, 2021

(54) TUNED MASS DAMPER IN AN EXTERIOR REARVIEW DEVICE

(71) Applicant: SMR Patents S.à.r.l., Luxembourg (LU)

(72) Inventor: Douglas Wilson, Troy, MI (US)

(21) Appl. No.: 17/168,669

(22) Filed: Feb. 5, 2021

Related U.S. Application Data
(63) Continuation-in-part of application No. 16/375,144, filed on Apr. 4, 2019, now Pat. No. 10,919,451.
Application No. 16/375,144 is a continuation-in-part of application No. 15/442,143, filed on Feb. 24, 2017, now Pat. No. 10,266,120.

(51) Int. Cl. F16F 15/067; B60R 1/06

(52) U.S. Cl. CPC F16F 15/067; F16F 2232/08; F16F 2238/026; B60R 1/06

(57) ABSTRACT

A motor vehicle includes mating features in a sheet metal of the motor vehicle, an exterior rearview device assembly fixedly secured to the motor vehicle, where the exterior rearview device assembly includes a structural base frame that mates to the mating features of the sheet metal at a mounting plane, and a tuned mass damper system secured to the structural base frame adjacent to the mounting plane. The tuned mass damper system includes more than one mass damper. In an example, a primary axis of movement of the tuned mass damper is at least one of substantially parallel with or substantially perpendicular to the mounting plane. In another example, the tuned mass damper is configured to dampen resonant vibrations being generated by the motor vehicle.

### CROSS-REFERENCE TO RELATED APPLICATION

This application is a continuation-in-part application of U.S. patent application Ser. No. 16/375,144, filed Apr. 4, 2019, which is a continuation-in-part of U.S. patent application Ser. No. 15/442,143, filed Feb. 24, 2017, each of which is hereby incorporated by reference in its entirety for all purposes.

### BACKGROUND OF THE INVENTION

### 1. Field of the Invention

The following description relates to exterior rearview devices such as a rearview camera pod or a rearview mirror that includes a tuned mass damping system, and vehicles including such exterior rearview devices.

### 2. Related Art

Functional performance of a product is essential to customer satisfaction. With respect to exterior rearview devices attached to automobiles, one of the most significant factors of customer satisfaction is the stability of the image that the driver sees in the device as he is checking for objects in his device. This is known as “On Road Vibration Performance” of the device (hereinafter “ORVP”). It is well known that all items have a frequency with which they resonate. With exterior rearview devices it is common knowledge that the higher the resonant frequency of the device, the better the ORVP. It is also common knowledge that the resonant frequency of a device is usually different in the vertical axis compared to the fore/aft axis and the in/out axis.

With all exterior rearview devices, and especially larger exterior rearview devices, the mass of the rearview device may be great and the center of gravity may be outboard. It is also well known that as the mass of an object increases, the resonant frequency decreases. This makes it more difficult to achieve acceptable ORVP on larger exterior rearview devices. In addition, with camera pods and devices which use digital image capturing means to capture a rearview image of the vehicle, stability is even more essential in order to capture a clear digital image.

Another challenge associated with achieving good ORVP with rearview devices, especially in larger vehicles, is the fact that the vehicle itself generates a wide range of resonant vibrations from items such as the engine, tire treads contacting the road surface, stiff high load suspensions, vibrations of the hood or floor-pan, or other larger sheet metal bodies. These resonant vibrations migrate to the rearview device mounting structure of the vehicle door. These resonant vibrations that present themselves in the rearview device mounting structure have a variety of frequencies and amplitudes which all feed into the rearview device structure and ultimately to the rearview device reflective surface. These vibration inputs from the vehicle then combine with the oscillations of the rearview device that are present due to inherent structural characteristics of the exterior rearview device itself and can result in poorer ORVP than desired.

Mass damping is known and mass dampers are commercially available. A typical mass damper includes a structurally rigid mounting plate, a block of material which constitutes the mass, and one or more flexible members that connect the mass with the mounting structure. A mass damper can be designed to specifically have the same resonant frequency regardless of which direction it is checked, while other mass dampers are designed to be more flexible in certain directions and less flexible in other directions resulting in different resonant frequencies in each axis. Previous applications of mass damping in an exterior rearview device involved mounting a mass damper close to the connection point of the reflective element, the display of the rearview device, the camera pod, and/or the structural member of the case. The results of mass damping at these points were not favorable as the added mass of the mass damper would increase the overall mass of the rearview device, and also move the rearview device's center of gravity outboard and in doing so, decrease the base resonant frequency of the rearview device head.

### SUMMARY

In one aspect, a motor vehicle includes a mating features in a sheet metal of the motor vehicle, and an exterior rearview device fixedly secured to the motor vehicle, the exterior rearview device including a structural base frame that mates to the mating features of the sheet metal at a mounting plane, and a tuned mass damper system secured to the structural base frame adjacent to the mounting plane, the tuned mass damper system including more than one mass damper, where a primary axis of movement of the tuned mass damper system is at least one of substantially parallel with or substantially perpendicular to the mounting plane.

The more than one mass damper may include a first mass damper and a second mass damper.

The first mass damper may be configured to dampen resonant vibrations at a first frequency, and the second mass damper may be configured to dampen resonant vibrations at a second frequency.

The first mass damper may be configured to dampen resonant vibrations along a first axis, and the second mass damper may be configured to dampen resonant vibrations along a second axis.

The tuned mass damper system may include a mass, a mounting shaft that is secured to the structural base frame and extends through the mass, a first spring system and a second spring.

The first mass damper may include the first spring system, the mass and the mounting shaft, and the second mass damper may include the second spring the mass and the mounting shaft.

The first spring system may include a top spring and a bottom spring, and the mass may be flanked by the top spring on a side and the bottom spring on another side, the mass may also contain an opening that houses the second spring.

The tuned mass damper system may include a first mass and a second mass, a first attaching element and a second attaching element, a first shaft formed of flexible material, and a second shaft formed of flexible material.

The first mass damper may include the first mass and the first shaft formed of flexible material, and the second mass damper may include the second mass and the second shaft formed of flexible material.

The first shaft formed of flexible material may include a primary shaft and a secondary shaft, and the first mass may be flanked by the primary shaft on one side and the secondary shaft on another, and the second shaft of flexible material may include a second primary shaft and a second secondary shaft and the second mass may be flanked by the second primary shaft on one side and the second secondary shaft on another.

The tuned mass damper system may be configured to dampen resonant vibrations being generated by the motor vehicle.

In another aspect, a motor vehicle may include a mating features in a sheet metal of the motor vehicle, and an exterior rearview device fixedly secured to the motor vehicle, the exterior rearview device including a structural base frame that mates to the mating features of the sheet metal at a mounting plane, and a tuned mass damper system with more than one mass damper secured to the structural base frame adjacent to the mounting plane, where the tuned mass damper is configured to dampen resonant vibrations being generated by the motor vehicle.

The more than one mass damper includes a first mass damper and a second mass damper.

The first mass damper may be configured to dampen resonant vibrations at a first frequency, and the second mass damper may be configured to dampen resonant vibrations at a second frequency.

The first mass damper may be configured to dampen resonant vibrations along a first axis, and the second mass damper may be configured to dampen resonant vibrations along a second axis.

The tuned mass damper system may include a mass, a mounting shaft that is secured to the structural base frame and extends through the mass, a first spring system and a second spring.

The first mass damper may include the first spring system, the mass and the mounting shaft, and the second mass damper may include the second spring the mass and the mounting shaft.

The first spring system may include a top spring and a bottom spring, and the mass may be flanked by the top spring on a side and the bottom spring on another side, the mass may also contain an opening that houses the second spring.

The tuned mass damper system may include a first mass and a second mass, a first attaching element and a second attaching element, a first shaft formed of flexible material, and a second shaft formed of flexible material.

The first mass damper may include the first mass and the first shaft formed of flexible material, and the second mass damper may include the second mass and the second shaft formed of flexible material.

The first shaft formed of flexible material may include a primary shaft and a secondary shaft, and the first mass may be flanked by the primary shaft on one side and the secondary shaft on the other, and the second shaft of flexible material may include a second primary shaft and a second secondary shaft and the second mass may be flanked by the second primary shaft on one side and the second secondary shaft on the other.

The primary axis of movement of the tuned mass damper system may be at least one of substantially parallel with or substantially perpendicular to the mounting plane.

### DESCRIPTION OF THE SEVERAL VIEWS OF THE DRAWINGS

The foregoing summary, as well as the following detailed description, will be better understood when read in conjunction with the appended drawings. For the purpose of illustration, there is shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIG. 1 is a front perspective view of an example of a conventional camera pod and a viewing side B.

FIG. 2 is a planar view of an example of the conventional camera pod of FIG. 1 as viewed from viewing side B, and including an axis A-A.

FIG. 3 is a cross-sectional view of a camera pod along the axis A-A of FIG. 2 including a first example of a mass damping system according to the invention.

FIG. 4 is a planar view of the conventional camera pod of FIG. 1 as viewed from viewing side B, and including another example of a mass damping system according to the invention.

FIG. 5 is a cross-sectional view of a camera pod along the axis A-A of FIG. 2 including another example of a mass damping system according to the invention.

FIG. 6 is a cross-sectional view of a camera pod along the axis A-A of FIG. 2 including another example of a mass damping system according to the invention.

FIG. 7 is a cross-sectional view along the axis A-A of FIG. 2. of another example of a mass damping system according to the invention.

### DETAILED DESCRIPTION OF THE INVENTION

Before explaining at least one example of the invention in detail, it is to be understood that the invention is not limited in its application to the details of construction and to the arrangements of the components set forth in the following description or illustrated in the drawings. The Figures and written description are provided to teach any person skilled in the art to make and use the inventions for which patent protection is sought. The invention is capable of other embodiments and of being practiced and carried out in various ways. Those skilled in the art will appreciate that not all features of a commercial embodiment are shown for the sake of clarity and understanding. Persons of skill in the art will also appreciate that the development of an actual commercial embodiment incorporating aspects of the present inventions will require numerous implementation-specific decisions to achieve the developer's ultimate goal for the commercial embodiment. While these efforts may be complex and time-consuming, these efforts nevertheless would be a routine undertaking for those of skill in the art having the benefit of this disclosure.

In addition, it is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” “corner,” are used in the description for clarity in specific reference to the Figures and are not intended to limit the scope of the invention or the appended claims. Further, it should be understood that any one of the features of the invention may be used separately or in combination with other features. Other systems, methods, features, and advantages of the invention will be or become apparent to one with skill in the art upon examination of the Figures and the detailed description. It is intended that all such additional systems, methods, features, and advantages be included within this description, be within the scope of the present invention, and be protected by the accompanying claims.

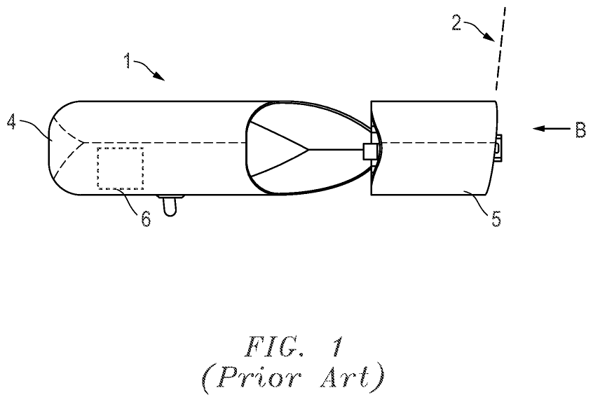

FIG. 1 is a front perspective view of a conventional camera pod 1 and a viewing side B. Referring to FIG. 1, a conventional camera pod 1 is attached to a vehicle 2 and is attached at a rearview device mounting plane of the vehicle door 2.

It should be appreciated that the camera pod 1 is a type of exterior rearview device and may be referred to interchangeably as the rearview device 1. In this example, the camera pod 1 may include one or more cameras 6 and may include a pivot joint between a case assembly 4 and a base assembly 5. The pivot joint may have any of a number of configurations to allow the case assembly 4 to pivot with respect to the base assembly 5.

Other examples of the rearview device 1 may include an exterior rearview or side-view mirror, a rearview or side-view display, a camera/display system, and/or any reflective or non-reflective element which provides a view of the rear or side of a vehicle. U.S. patent application Ser. No. 15/442,143, which is incorporated by reference herein for all purposes, describes an exterior rearview device which is a rearview mirror. For convenience and ease of illustration, the rearview device 1 is illustrated as a camera pod 1. It should be appreciated that the following description is applicable to any example of a rearview device 1 although a camera pod 1 is illustrated.

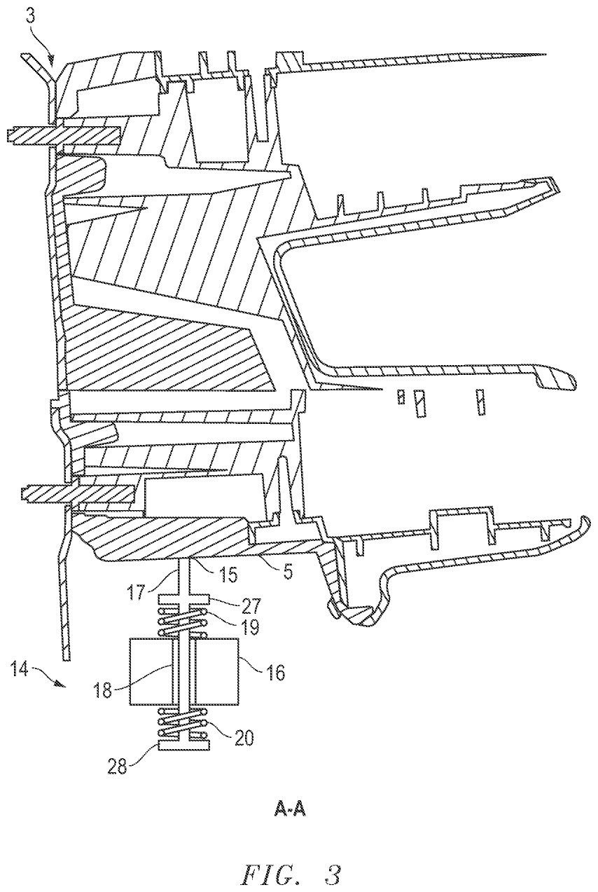

The rearview device 1 includes the rearview device base assembly 5 having a base frame and a base cover. The rearview device 1 also include the rearview device case assembly 4 having, among other things, a rearview device case and a case frame. In an example, a rearview device 1 may include one or more of a camera 6, a display, or a reflective element such as a mirror. In the examples described below and illustrated in FIGS. 3-7, a tuned mass damper assembly 12, 14, 30, 50, 60 is shown secured to the base frame at a position adjacent to a rearview device mounting plane.

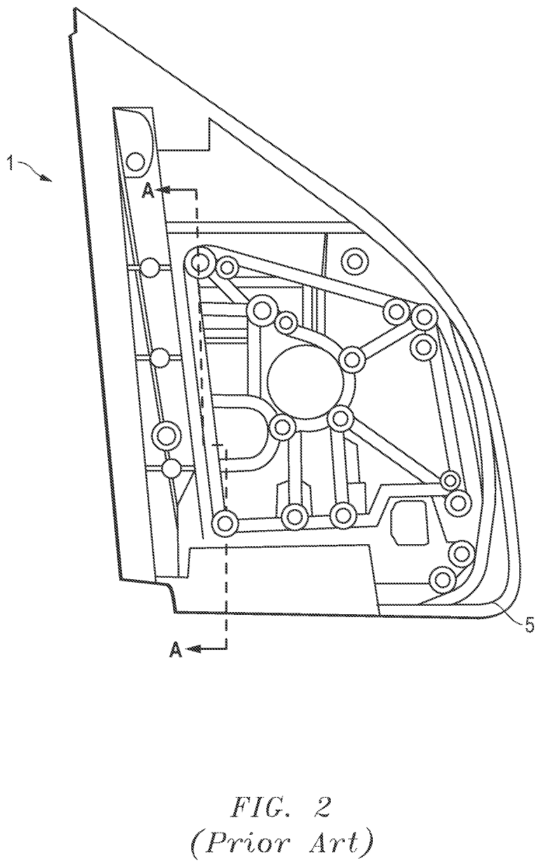

FIG. 2 is a planar view of the conventional rearview device 1 of FIG. 1 as viewed from viewing side B, and including an axis A-A.

Referring to FIG. 2, the base assembly 5 of the conventional rearview device 1 does not include a mass damper assembly at the base frame. Typically, a mass damper assembly is mounted close to the connection point of the reflective element, rearview camera, rearview display, and/or the structural member of the case.

FIG. 3 is a cross-sectional view of a rearview device 1 along the axis A-A of FIG. 2 including a first example of a mass damping system 14 according to the invention.

Referring to FIG. 3, one embodiment of a tuned mass damper assembly 14 is illustrated, which is secured to the rearview device base assembly 5 adjacent to a mounting plane 3. In this example, the mass 16 includes a solid block of heavy material, such as steel, aluminum, lead or some other material. The mass 16 is not limited to a solid block but may include any solid structure, any structure with holes, openings, or slots, and any structure with an abstract shape. Examples of other materials include polymers, ceramics, and any high-gravity compound (HGC) material which may, but does not have to, include a filler. Also included is the mounting shaft 17 which is secured to the base frame at position 15 on one end. The other end of the mounting shaft 17 extends through a hole 18 in the center of the mass 16. The mass 16 is held in position by springs 19 and 20. Spring 19 has one end abutting a flange 27 on the upper end of mounting shaft 17 while the other end abuts the upper side of mass 16. Likewise, spring 20 has one end abutting with a flange 28 on the lower end of the mounting shaft 17 while the other end of spring 20 abuts with the lower side of mass 16. In this manner, the mass 16 is allowed to move along the axis of the mounting shaft 17 when the force applied is greater that the resultant forces of the springs 19 and 20 that hold the mass 16 in position.

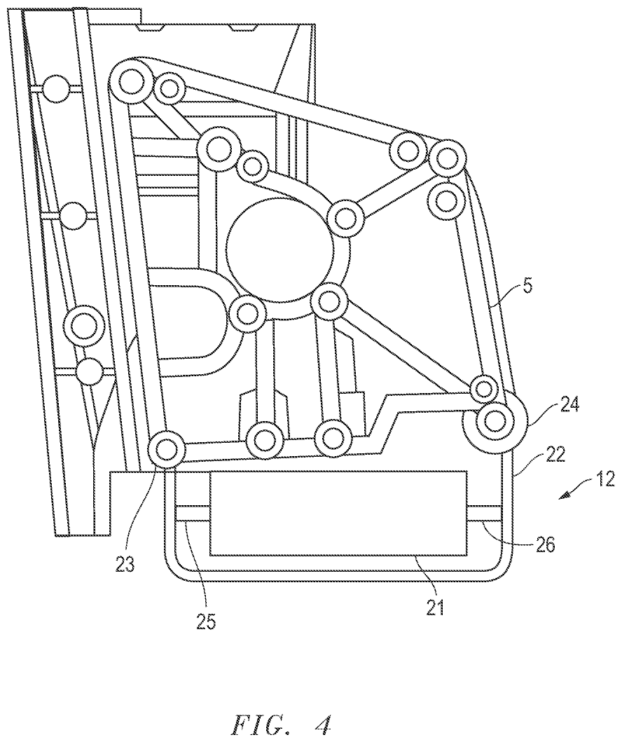

FIG. 4 is a planar view of a rear-view device as viewed from viewing side B of FIG. 1, and including another example of a mass damping system 12 according to the invention.

Referring to FIG. 4, another embodiment of a tuned mass damper assembly 12 is illustrated, in which the mass 21 includes a solid block of heavy material, such as steel, aluminum, lead or some other similar material. Also included is a mounting plate 22 which is secured to the base assembly 5 at a first position 23 and a second position 24. Mass 21 is secured to mounting plate 22 using two flexible members 25 and 26. Mass damping is achieved in this embodiment because flexible members 25 and 26 allow the mass 21 to resonate in response to vibration inputs transmitted through the vehicle.

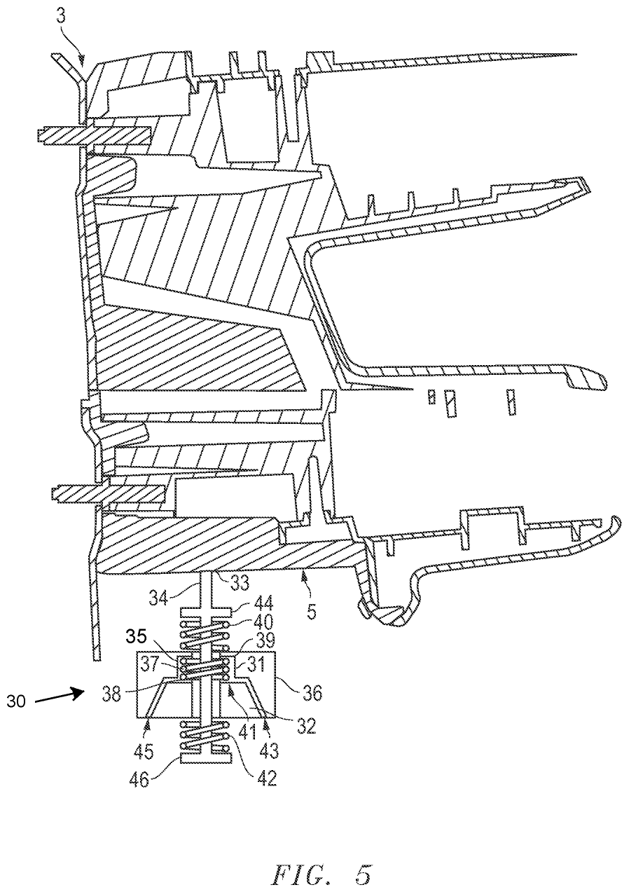

FIG. 5 is a cross-sectional view of a rearview device 1 along the axis A-A of FIG. 2 including a first example of a multi-frequency mass damping system 30 according to the invention.

Referring to FIG. 5, one embodiment of a multi-frequency tuned mass damper assembly 30 is illustrated, which is secured to the rearview device base assembly 5 adjacent to a mounting plane 3. Multi-frequency tune mass damper assembly 30 has a first mass damper 32 and a second mass damper 35. In this example, the mass 36 includes a solid block of heavy material, such as steel, aluminum, lead or some other material. The mass 36 is not limited to a solid block but may include any solid structure, any structure with holes, openings, or slots, and any structure with an abstract shape. Examples of other materials include polymers, ceramics, and any high-gravity compound (HGC) material which may, but does not have to, include a filler. Also included is the mounting shaft 34 which is secured to the base frame at position 33 on one end. The other end of the mounting shaft 34 extends through a hole 38 in the center of the mass 36. The mass 36 is held in position by springs 40 and 42. Spring 40 has one end abutting a flange 44 on the upper end of mounting shaft 34 while the other end abuts the upper side of mass 36. Likewise, spring 42 has one end abutting with a flange 46 on the lower end of the mounting shaft 34 while the other end of spring 42 abuts with the lower side of mass 36. In this manner, the mass 36 is allowed to move along the axis of the mounting shaft 34 when the force applied is greater that the resultant forces of the springs 40 and 42 that hold the mass 36 in position. Mass 36 also has opening 31. A secondary spring 37 is contained within opening 31. Secondary spring 37 abuts a top 39 of the opening 31 of mass 36 on a first end and a bottom 41 of the opening 31 of mass 36 on a second end. Opening 31 continues to opening 45 of mass 36 on a left side, and opening 31 continues to opening 43 of mass 36 on a right side. In this manner, mass 36 is allowed to move along the axis of the mounting shaft 34 when the force applied is greater than that of the resultant force of spring 37.

Spring 40 and spring 42 can have a different resultant force than does spring 37, which allows multi-frequency tune mass damper assembly 30 to dampen in response to different frequencies, thereby addressing multiple damping needs. In this regard, first frequency mass damper 35 can dampen a lower frequency, and second frequency mass damper 32 can dampen a higher frequency. In other examples, first frequency mass damper 35 can dampen a higher frequency, and second frequency mass damper 32 can dampen a lower frequency. Spring 40 and 42 can also have the same resultant force as spring 37, which allows first frequency mass damper 35 to dampen in response to the same frequency as mass damper 32.

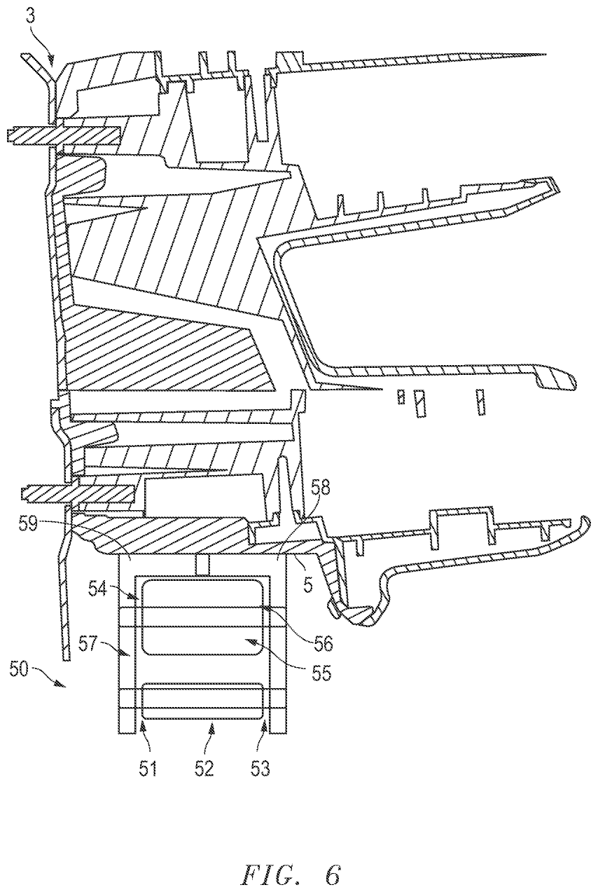

FIG. 6 is a cross-sectional view of a rearview device 1 along the axis A-A of FIG. 2 including another example of a multi-frequency mass damping system 50 according to the invention.

Referring to FIG. 6, another embodiment of a multi-frequency tuned mass damper assembly 50 is illustrated, which is secured to the rearview device base assembly 5 adjacent to mounting plane 3. In this example, first mass 52 and second mass 55 both include a solid block of heavy material, such as steel, aluminum, lead or some other similar material. Also included is a mounting plate 57 which is secured to the base assembly 5 at a first position 58 and a second position 59. First mass 52 is secured to mounting plate 57 using two flexible members 51 and 53. Second mass 55 is secured to mounting plate 57 using two flexible members 54 and 56. Mass damping is achieved in this embodiment because flexible members 51 and 53 allow the mass 52 to resonate in response to vibration inputs transmitted through the vehicle, and flexible members 54 and 56 allow the mass 55 to resonate in response to vibration inputs transmitted through the vehicle.

In some examples, flexible members 54 and 56 allow mass 55 to resonate in response to vibration inputs at a first frequency transmitted through the vehicle, and flexible members 51 and 53 allow mass 52 to resonate in response to vibration inputs at a second frequency transmitted through the vehicle. In other examples, flexible members 54 and 56, and 51 and 53 allow both mass 52 and mass 55 to resonate in response to vibration inputs at the same frequency.

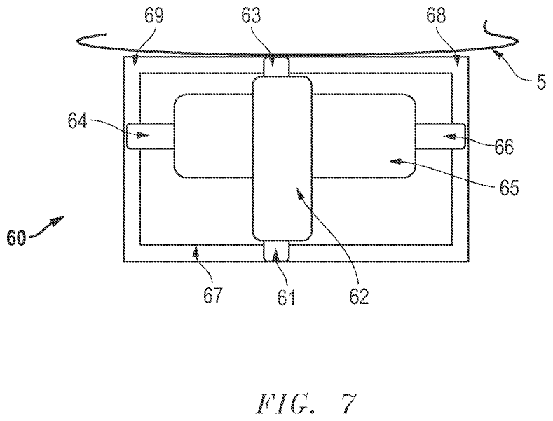

FIG. 7 is a cross-sectional view along the axis A-A of FIG. 2 of another example of a mass damping system 60 according to the invention.

Referring to FIG. 7, another embodiment of a multi-frequency tuned mass damper assembly 60 is illustrated, which is secured to the rearview device base assembly 5. In this example, of tuned mass damper assembly 60, the first mass 62 includes a solid block of heavy material, such as steel, aluminum, lead, or some other similar material. The second mass 65 also includes a solid block of heavy material, such as steel, aluminum, lead, or some other similar material. Also included is mounting plate 67 which is secured to the base assembly 5 at a first position 68 and a second position 69. Mass 62 is secured to mounting plate 67 using two flexible members 61 and 63. Mass 65 is secured to mounting plate 67 using two flexible members 64 and 66.

Mass damping is achieved in this embodiment along two different axis because flexible members 61 and 63 allow mass 62 to resonate in response to vibration inputs transmitted through the vehicle along a first axis, and flexible members 64 and 66 allow mass 65 to resonate in response to vibration inputs transmitted through the vehicle along a second axis. In this embodiment, mass 64 is substantially perpendicular to mass 66, however, it should be appreciated that the embodiment shown is not limited to two perpendicular axis. The two masses can be placed along any two different axis to in order to address multiple damping needs.

There can be more than one frequency inputs effecting the ORVP. The embodiments shown in FIG. 5, FIG. 6, and FIG. 7 allow the mass dampening system to address multiple dampening needs. This is much like a multi-octave bell that can be made to produce different musical notes by altering the bell's geometry and by thinning or thickening different sections of the outer wall of a bell.

It should be appreciated that the embodiments shown in FIG. 5, FIG. 6, and FIG. 7 are not limited to two mass dampers but rather may have any numbers of mass dampers as is necessary to address multiple dampening needs and to optimize ORVP.

In an aspect of the above described embodiments and descriptions, a tuned mass damper system 12, 14, 30, 50, 60 is secured to the rearview device base adjacent to a mounting plane 3. If packaging space permits, this can be mounted into the structure of the base frame proper. In another aspect of the above described embodiments and descriptions, a tuned mass damper system 60 is shown secured to the review device base assembly 5. The mass damper system 12, 14, 30, 50, 60 may be designed to have a greater degree of flexibility in the axis or axes that has/have the greatest amount of resonant vibration, or energy input as produced by the vehicle. In this sense, as described, the mass damper system is considered “tuned”. With the mass damper system located as close as possible to the mounting plane 3 of the exterior rearview device, it does not increase the amount of suspended mass at the outboard end of the rearview device. This moves the relative rearview device center of gravity inboard and thus does not decrease the resonant frequency of the rearview device. By being located inboard of and adjacent to the rearview device mounting plane 3 of the door, the mass damper system has the effect of smoothing out the resonant vibrations that are produced by the vehicle that would otherwise be input directly to the rearview device. By smoothing out the vibration inputs into the rearview device, the ORVP of the rearview device is significantly improved.

In an aspect, adjacent to the rearview device mounting plane 3 is preferably within a range of about 2 to about 10 millimeters from the rearview device mounting plane 3; however, this range is not limited thereto. For example, the range includes at least 2 millimeters, at least 3 millimeters, at least 4 millimeters, at least 5 millimeters, at least 6 millimeters, at least 7 millimeters, at least 8 millimeters, at least 9 millimeters, at least 10 millimeters, at most 2 millimeters, at most 3 millimeters, at most 4 millimeters, at most 5 millimeters, at most 6 millimeters, at most 7 millimeters, at most 8 millimeters, at most 9 millimeters, and at most 10 millimeters from the rearview device mounting plane. In a further example, a range from about 0 to about 50 millimeters from the mounting plane 3 is also described.

The apparatus of the present invention has been described above and in the attached drawings; however, modifications will be apparent to those of ordinary skill in the art and the scope of protection for the invention is to be defined by the claims that follow.

1. A motor vehicle, comprising:
mating features in a sheet metal of the motor vehicle; and
an exterior rearview device fixedly secured to the motor vehicle, the exterior rearview device comprising
a structural base frame that mates to the mating features of the sheet metal at a mounting plane; and
a tuned mass damper system secured to the structural base frame adjacent to the mounting plane, the tuned mass damper system comprising more than one mass damper,
wherein a primary axis of movement of the tuned mass damper system is at least one of substantially parallel with or substantially perpendicular to the mounting plane.

2. The motor vehicle of claim 1, wherein the more than one mass damper comprises a first mass damper and a second mass damper.

3. The motor vehicle of claim 2, wherein the first mass damper is configured to dampen resonant vibrations at a first frequency, and the second mass damper is configured to dampen resonant vibrations at a second frequency.

4. The motor vehicle of claim 2, wherein the first mass damper is configured to dampen resonant vibrations along a first axis and the second mass damper is configured to dampen resonant vibrations along a second axis.

5. The motor vehicle of claim 2, wherein the tuned mass damper system comprises a mass;
a mounting shaft that is secured to the structural base frame and extends through the mass; and
a first spring system and a second spring.

6. The motor vehicle of claim 5, wherein the first mass damper comprises the first spring system, the mass, and the mounting shaft, and the second mass damper comprises the second spring, the mass, and the mounting shaft.

7. The motor vehicle of claim 5, wherein the first spring system comprises a top spring and a bottom spring, the mass is flanked by the top spring on a side and the bottom spring on another side, and the mass comprises an aperture and the second spring is housed inside the aperture.

8. The motor vehicle of claim 2, wherein the tuned mass damper system comprises
a first mass;
a second mass;
a first attaching element and a second attaching element;
a first shaft formed of flexible material; and
a second shaft formed of flexible material.

9. The motor vehicle of claim 8, wherein the first mass damper comprises the first mass, and the first shaft formed of flexible material, and the second mass damper comprises the second mass and the second shaft formed of flexible material.

10. The motor vehicle of claim 8, wherein the first shaft formed of flexible material comprises a primary shaft and a secondary shaft, and the first mass is flanked by the primary shaft on a side and the secondary shaft on another side, and wherein the second shaft formed of flexible material comprises a second primary shaft and a second secondary shaft, and the second mass is flanked by the second primary shaft of a second side and the second secondary shaft on another side.

11. The motor vehicle of claim 1, wherein the tuned mass damper system is configured to dampen resonant vibrations being generated by the motor vehicle.

12. A motor vehicle, comprising:
mating features in a sheet metal of the motor vehicle; and
an exterior rearview device fixedly secured to the motor vehicle, the exterior rearview device comprising
a structural base frame that mates to the mating features of the sheet metal at a mounting plane; and
a tuned mass damper system secured to the structural base frame adjacent to the mounting plane, comprising more than one mass damper,
wherein the tuned mass damper system is configured to dampen resonant vibrations being generated by the motor vehicle.

13. The motor vehicle of claim 12, wherein the more than one mass damper comprises a first mass damper and a second mass damper.

14. The motor vehicle of claim 13, wherein the first mass damper is configured to dampen resonant vibrations at a first frequency, and the second mass damper is configured to dampen resonant vibrations at a second frequency.

15. The motor vehicle of claim 13, wherein the first mass damper is configured to dampen resonant vibrations along a first axis and the second mass damper is configured to dampen resonant vibrations along a second axis.

16. The motor vehicle of claim 13, wherein the tuned mass damper system comprises
a mass;
a mounting shaft that is secured to the structural base frame and extends through the mass; and
a first spring system and a second spring.

17. The motor vehicle of claim 16, wherein the first mass damper comprises the first spring system, the mass, and the mounting shaft, and the second mass damper comprises the second spring, the mass, and the mounting shaft.

18. The motor vehicle of claim 17, wherein the first spring system comprises a top spring and a bottom spring, the mass is flanked by the top spring on a side and the bottom spring on another side, and the mass comprises an aperture and the second spring is housed inside the aperture.

19. The motor vehicle of claim 13, wherein the tuned mass damper system comprises
a first mass;
a second mass;
a first attaching element and a second attaching element;
a first shaft formed of flexible material; and
a second shaft formed of flexible material.

20. The motor vehicle of claim 19, wherein the first mass damper comprises the first mass, and the first shaft formed of flexible material, and the second mass damper comprises the second mass and the second shaft formed of flexible material.

21. The motor vehicle of claim 19, wherein the first shaft formed of flexible material comprises a primary shaft and a secondary shaft, and the first mass is flanked by the primary shaft on a side and the secondary shaft on another side, and wherein the second shaft formed of flexible material comprises a second primary shaft and a second secondary shaft, and the second mass is flanked by the second primary shaft of a second side and the second secondary shaft on another side.

22. The motor vehicle of claim 12, wherein a primary axis of movement of the tuned mass damper system is at least one of substantially parallel with or substantially perpendicular to the mounting plane.
